(19) United States
(12) Patent Application Publication
(10) Pub. No.: US 2026/0336951 A1
(43) Pub. Date: Oct. 29, 2026

(54) VACUUM SUCTION CUP BASED ON SNAP-ON TYPE GASKET STRUCTURE

(71) Applicant: Zhejiang Shijing Tools Co., Ltd., Wuyi (CN)

(72) Inventors: Min Xu, Jinhua (CN); Shuaijie Xu, Jinhua (CN)

(73) Assignee: Zhejiang Shijing Tools Co., Ltd., Wuyi (CN)

(21) Appl. No.: 19/393,550

(22) Filed: Nov. 18, 2025

(30) Foreign Application Priority Data
Nov. 20, 2024 (CN) 2024116615086
Nov. 21, 2024 (CN) 2024228360435
Nov. 21, 2024 (CN) 2024228374052
Nov. 10, 2025 (CN) 2025116391573

(51) Int. Cl. B65G 49/06; B25J 15/06

(52) U.S. Cl. CPC B65G 49/061; B25J 15/0683

(57) ABSTRACT

The present disclosure discloses a vacuum suction cup based on a snap-on type gasket structure, including a suction cup frame (1), a handle (2) and a gasket (3) connected to one another, where an engaging groove (101) is provided on a periphery of a bottom of the suction cup frame (1), the gasket (3) is in snap-fit connection with the engaging groove (101) at a periphery by virtue of an engaging portion (301), and a bracket (5) located in the engaging groove (101) is provided in a middle portion of the gasket (3). The present disclosure can ensure the stable mounting of the gasket while enabling the separate replacement of the gasket and facilitates the removal and mounting of a battery by an operator.

The present application claims priorities to Chinese Patent Applications 2024228374052, 2024228360435 and 2024116615086, filed on Nov. 20, 2024, and a Chinese Patent Application 2025116391573 filed on Nov. 10, 2025. The contents of the Chinese patent applications are incorporated herein by reference in their entireties.

### TECHNICAL FIELD

The present disclosure relates to a vacuum suction cup, and in particular to a vacuum suction cup based on a snap-on type gasket structure.

### BACKGROUND

An electric suction cup is a common handling tool that suctions a suctioned object tightly by fitting a gasket at a bottom of the suction cup to the suctioned object and then suction the air between a base and the suctioned object to create a vacuum by means of sealing effect, so as to achieve a handling effect. When the electric suction cup finishes the handling, pressure relief is performed on a suction chamber between the base and the suctioned object to break the negative-pressure vacuum state in the suction chamber to allow the base of the suction cup to be freed from the suctioned object. On this basis, in a traditional vacuum suction cup, a gasket is mounted by directly fixing the gasket at a bottom of a frame, but the sealing stability of the gasket may be influenced by factors such as bumping and deformation during long-term use. This results in the need for a user to replace the gasket with the suction cup frame during maintenance, which increases the cost of replacement of the gasket.

For this problem, at present, some manufacturers mount the gasket by means of snap-fit of the gasket with the suction cup frame. However, this mounting method can only apply to gasket structures of hard rubber material, and gasket structures of soft rubber material may experience curling deformation and loose peeling due to excessive stress after being snapped into place, that is, it cannot ensure stable snap-fit with the suction cup frame. Compared to soft rubber, the disadvantage of a gasket of hard rubber material is that due to the weak deformability of the hard rubber, a gap tends to form at an attachment when a suctioned object with an uneven surface is suctioned, which affects the sealing performance of the gasket and the handling stability of the electric suction cup.

Secondly, in an existing electric suction cup, a battery is mounted by fixing a battery compartment in a handle of the electric suction cup and providing a snap-on cover plate outside the battery compartment. During operation, it is required for an operator to first release and remove the cover plate, then insert the battery into the battery compartment, and finally close the cover plate again to complete the mounting. This method will undoubtedly increase the operator's difficulty and easily cause the cover plate to be loosened and get lost after long-term use. Furthermore, there are currently two methods to relieve the pressure of the suction chamber, the first one, as shown in Patent No. 202210981748.9, is by providing a release tab on a side of the gasket. This allows the operator to lift a local part of the gasket using the release tab, breaking the fully sealed state of the suction chamber and achieving the pressure relief function. The second one, as shown in Patent No. 202010684221.0, is by providing an air valve in communication with the suction chamber on the electric suction cup to maintain the air valve in a closed state under the constraint of a negative pressure in normal use. When pressure relief is needed for the electric suction cup, the operator can open the air valve to allow the suction chamber to communicate with the outside, thus achieving the pressure relief function. However, both of the methods of pressure relief require the operator to directly break the negative-pressure condition in the suction chamber with a large force, thus increasing the difficulty of pressure relief of the electric suction cup. At present, in order to ensure the connection strength and sealing of the gasket at the bottom of the suction cup, existing manufacturers generally fix the gasket directly at the bottom of the suction cup and the gasket is not detachable, resulting in that when the gasket is damaged and its sealing effect is influenced, the user need to replace the entire chassis, which increases the subsequent maintenance cost of the electric suction cup. On the other hand, the material of the gasket is relatively soft. As a result, if the manufacturers connect the gasket to the bottom of the suction cup in a detachable way by conventional methods such as snap-fit, the gasket is prone to curling deformation and loose shift after being stressed, which in turn impairs the sealing performance between the gasket and the suction cup and thus the handling stability.

As a result, existing electric suction cups cannot ensure the stable mounting of the gasket while enabling the separate replacement of the gasket, and suffers from the problem of inconvenient battery removal and mounting.

### SUMMARY

An objective of the present disclosure is to provide a vacuum suction cup based on a snap-on type gasket structure. The vacuum suction cup can ensure the stable mounting of a gasket while enabling the separate replacement of the gasket and facilitates the removal and mounting of a battery by an operator.

The technical solution of the present disclosure is provided. A vacuum suction cup based on a snap-on type gasket structure includes a suction cup frame, a handle and a gasket connected to one another, where an engaging groove is provided on a periphery of a bottom of the suction cup frame, the gasket is in snap-fit connection with the engaging groove at a periphery by virtue of an engaging portion, and a bracket located in the engaging groove is provided in a middle portion of the gasket.

In the foregoing vacuum suction cup based on a snap-on type gasket structure, an annular lip is provided on a periphery of a bottom of the gasket, an upper end of the lip forms a deformation slot having an elongated cross section, an upper end of the deformation slot extends to an inside of the engaging groove, and a lower end of the deformation slot is located outside the engaging groove.

In the foregoing vacuum suction cup based on a snap-on type gasket structure, an annular retaining edge is formed on a periphery of the suction cup frame, a lower end of the retaining edge is located vertically below a bottom surface of the engaging portion, and the lip is located below the retaining edge and is vertically spaced apart from the retaining edge.

In the foregoing vacuum suction cup based on a snap-on type gasket structure, the suction cup frame and the gasket are connected to each other by means of screws, ends of the screws passing through the bracket and being threadedly connected to the suction cup frame.

In the foregoing vacuum suction cup based on a snap-on type gasket structure, a third vent and a fourth vent for ventilation are provided on the gasket and the suction cup frame, respectively, the third vent and the fourth vent being misaligned with each other, and a suction channel is distributed on the bottom of the suction cup frame, two sides of the suction channel communicating with the third vent and the fourth vent, respectively, and the suction channel being configured to hold the gasket in close fit with the suction cup frame when the vacuum suction cup performs suction; and a dust-proof piece is snap-fit connected in a middle portion of each of the third vent and the fourth vent.

In the foregoing vacuum suction cup based on a snap-on type gasket structure, a suction pump and a power-on assembly is each provided in the handle, the power-on assembly including a battery compartment in snap-fit connection with the handle, a power connection plate being provided at a lower end of the battery compartment, a power connection base that is fixedly connected in the handle being provided outside of the power connection plate, one end of the power connection base fitting with the power connection plate via an elastic power-on portion, and the other end of the power connection base being electrically connected to the suction pump.

In the foregoing vacuum suction cup based on a snap-on type gasket structure, a cover plate pivotally connected to the handle is provided at an outer end of the battery compartment, where an end of the cover plate extends inside the handle and forms a hook, a power-on button is snap-fit connected outside the hook, an end of the power-on button away from the hook is in snap-fit connection with the handle, and an inner side of the power-on button is connected to the handle via a first elastic member.

In the foregoing vacuum suction cup based on a snap-on type gasket structure, a suction pump and a pressure relief assembly are each provided in the handle, a bottom of the gasket is recessed inwardly to create a suction chamber, and the suction pump, the pressure relief assembly and the suction chamber are in communication with one another; and the pressure relief assembly includes an inlet and outlet pipe, a first vent, a second vent and an exhaust port being all provided on the inlet and outlet pipe, an exterior of the first vent being connected to the suction pump, an exterior of the second vent being connected to the suction chamber, a pressure relief button being provided outside the exhaust port, the pressure relief button being pivotally connected to the handle in a middle portion, a plug fitting with the exhaust port being provided at one end of the pressure relief button, and the pressure relief button being provided with a pressing portion for controlling the rotation of the pressure relief button at the other end.

In the foregoing vacuum suction cup based on a snap-on type gasket structure, an opening fitting with the pressing portion is provided on a side wall of the handle, an outer end of the pressing portion is in snap-fit with the opening, and an inner end of the pressing portion is connected to the handle via a second elastic member; and when the pressure relief button is in a pressed state, a gap for gas circulation is formed between the pressing portion and the opening.

In the foregoing vacuum suction cup based on a snap-on type gasket structure, a gas pressure sensor is externally connected to the inlet and outlet pipe.

Compared to the prior art, the present disclosure has the following characteristics.

(1) According to the present disclosure, a connecting structure for the gasket is defined in such a way that the gasket, when being mounted, can be snap-fit connected at the bottom of the suction cup frame by means of the engaging groove fitting with the engaging portion, such that, on one hand, a labyrinth groove structure is formed between the gasket and the suction cup frame, i.e., improving the sealing effect at a connection between the two; and on the other hand, it is also possible to use the cooperation of the bracket and the engaging groove to provide hard limit for the engaging portion to prevent the peeling-off of the gasket.

(2) On the above basis, the bracket is connected to the bottom of the suction cup frame by means of screws, and the bracket can press and limit the external gasket after fixing, which prevents the gasket from being detached from the suction cup frame due to stress-induced deformation, thereby improving the mounting stability and sealing effect of the gasket; the third vent and the fourth vent are distributed in a misaligned manner and communicate with each other through the suction channel, such that the air in the suction chamber is allowed to be exhausted sequentially through the third vent, the suction channel and the fourth vent upon suction, which in turn causes the suction channel to suction the inner end face of the gasket in the negative-pressure state, i.e., ensuring the mounting stability and sealing effect of the gasket in use; and with the above cooperation, both methods for mounting the gasket can enable the separate removal and mounting of the gasket while ensuring the mounting stability of the gasket.

(3) By means of the structural cooperation of the lip, the deformation slot and the retaining edge, on the one hand, the deformability of the lip can be improved such that the lip can be folded down and fit closely with the surface of the object when the suction chamber is in the negative-pressure state, improving the sealing effect; and on the other hand, when the operator presses the vacuum suction cup, it is also possible to limit the lip by means of the retaining edge, that is, to prevent the lip from being bonded to the engaging portion above the lip after deformation caused by the pressure and from affecting the subsequent folding effect, further improving the sealing effect of the gasket.

(4) The structure of the power-on assembly is defined such that the operator can mount and remove the battery compartment simply by pressing the power-on button to release the cover plate from the snap-fit limit and the battery compartment pushing the cover plate open and popping out under the rebound action of the elastic power-on portion, thereby facilitating the removal, mounting and replacement of the battery compartment by the operator;

(5) The structure of the pressure relief assembly is defined such that, on the one hand, the plug can be controlled to close or move away from the exhaust port by pressing the pressure relief button, to achieve the pressure relief function; and on the other hand, the pressure relief button can also be formed as a lever structure, that is, to effectively reduce the magnitude of a pressing force required to rotate the pressure relief button to open the plug, thereby facilitating the operation of the user.

(6) The opening fitting with the pressure relief button is provided on the side wall of the handle such that the pressure relief button can be snap-fitted to the opening in the non-pressure relief state under the pressing action of the second elastic member, thereby achieving the sealing of an inner cavity of the handle to prevent external impurities from entering the handle which otherwise causes clogging; and when the user presses the pressing portion to perform the pressure relief, a gap for entry of a gas is formed between the pressing portion and the opening, thereby realizing the quick pressure relief function.

(7) The inlet and outlet pipe, the exhaust port, the pressure relief button and the plug cooperate structurally such that the operator can control the plug to close or move away from the exhaust port by means of the pressure relief button, thereby achieving the pressure relief function; and by pivotally connecting the pressure relief button in the vacuum suction cup and defining the position of the pressing portion, the pressure relief button can be formed as a lever structure, that is, to effectively reduce the magnitude of a pressing force required to rotate the pressure relief button to open the plug, thereby facilitating the operation of the user.

(8) A connecting structure between the vacuum suction cup and the gasket is defined such that the periphery of the gasket can be snap-fitted to the engaging groove of the bottom of the suction cup frame by means of the engaging portion and the bracket, to achieve a sealing effect. On this basis, the first gas passage hole communicates with the second gas passage hole via the suction channel such that the vacuum suction cup can also keep the suction channel in the negative-pressure state upon suction, which in turn suctions the gasket below to prevent the problem of shift or detachment of the gasket under a stress, further improving the connection stability between the gasket and the suction cup frame and the sealing effect.

Therefore, the present disclosure can ensure the stable mounting of a gasket while enabling the separate replacement of the gasket and facilitates the removal and mounting of the battery by an operator. Furthermore, it can also facilitate the pressure relief operations by the operator, and ensure the sealing effect of the gasket while enabling the separate replacement of the gasket.

### BRIEF DESCRIPTION OF THE DRAWINGS

FIG. 1 is a schematic structural diagram of Embodiment 1;

FIG. 2 is a schematic structural diagram of a pressure relief assembly;

FIG. 3 is an enlarged view of part A of FIG. 1;

FIG. 4 is an enlarged view of part B of FIG. 1;

FIG. 5 is an enlarged view of part C of FIG. 1;

FIG. 6 is an outline view of Embodiment 1;

FIG. 7 is a schematic structural diagram of Embodiment 2;

FIG. 8 is an outline view of Embodiment 2;

FIG. 9 is an outline view of Embodiment 2 with a gasket removed;

FIG. 10 is a schematic structural diagram of Embodiment 3;

FIG. 11 is a schematic structural diagram of Embodiment 3;

FIG. 12 is an enlarged view of part A of FIG. 11;

FIG. 13 is an outline view of Embodiment 4; and

FIG. 14 is an outline view of FIG. 13 with a gasket removed.

### LIST OF REFERENCE SIGNS:

### Embodiments 1-2

1—suction cup frame, 2—handle, 3—gasket, 4—screw, 5—bracket, 6—suction pump, 7—battery compartment, 8—power connection plate, 9—power connection base, 10—elastic power-on portion, 11—cover plate, 12—power-on button, 13—first elastic member, 14—suction chamber, 15—inlet and outlet pipe, 16—pressure relief button, 17—plug, 18—second elastic member, 19—gas pressure sensor, 20—dust-proof piece, 101—engaging groove, 102—retaining edge, 103—fourth vent, 104—suction channel, 201—opening, 301—engaging portion, 302—lip, 303—deformation slot, 304—third vent, 111—hook, 151—first vent, 152—second vent, 153—exhaust port, 154—third exhaust port, 161—pressing portion;

### Embodiments 3-4

1—inlet and outlet pipe, 2—first vent, 3—second vent, 4—exhaust port, 5—pressure relief button, 6—plug, 7—pressing portion, 8—elastic member, 9—detection port, 10—suction cup frame, 11—handle, 12—suction pump, 13—first gas passage hole, 14—suction chamber, 15—gas pressure sensor, 16—opening, 17—gasket, 18—second gas passage hole, 19—suction channel, 20—engaging groove, 21—engaging portion, 22—bracket.

### DETAILED DESCRIPTION OF THE PREFERRED EMBODIMENTS

The present disclosure will be further described below with reference to the accompanying drawings and embodiments, which are not construed as limiting the present disclosure.

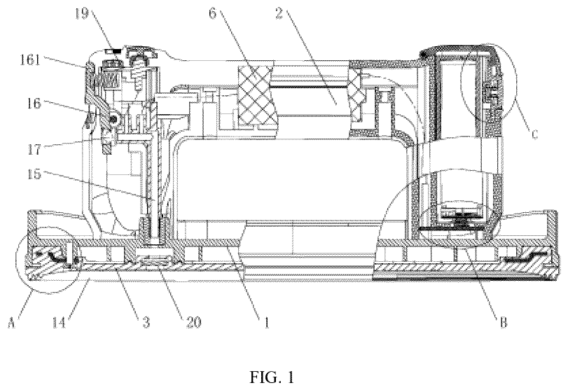

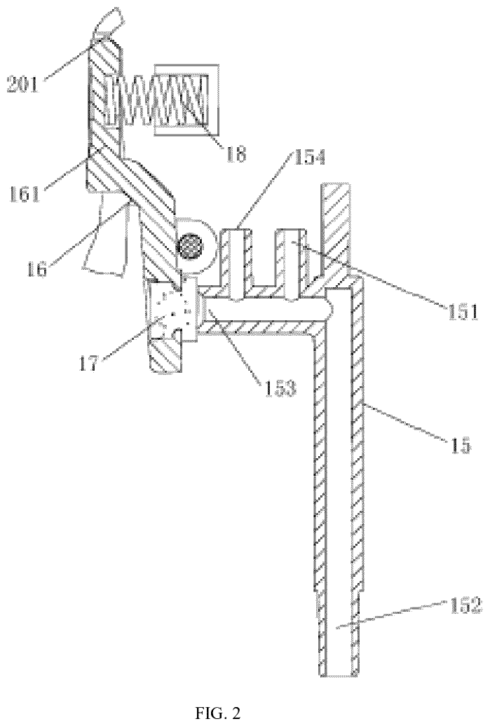

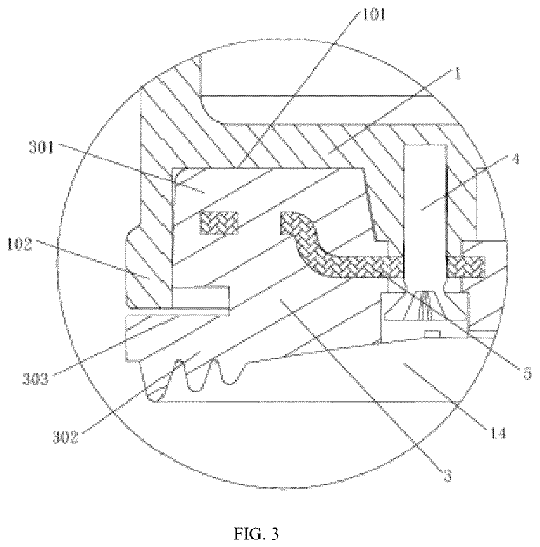

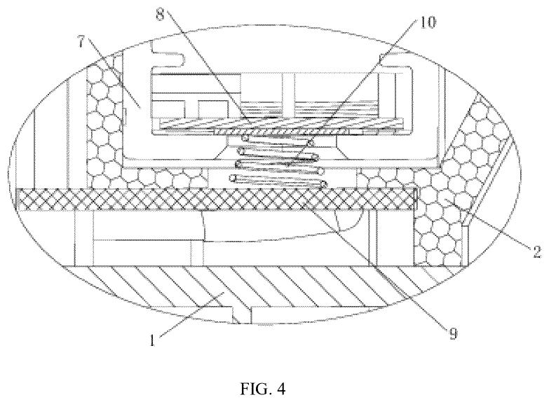

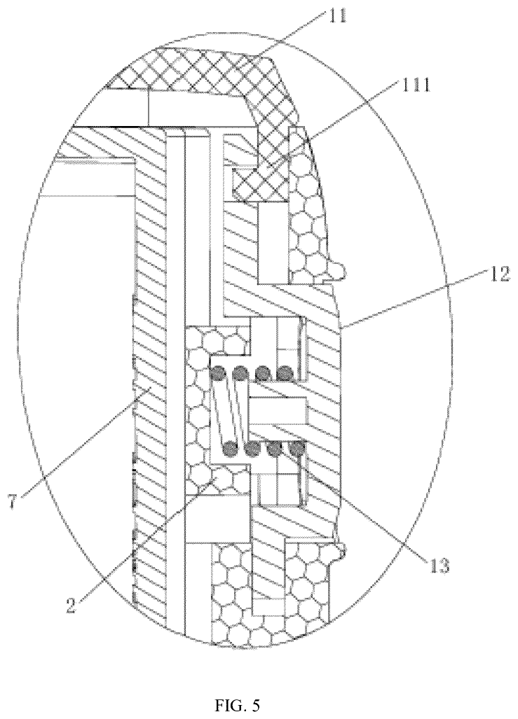

Embodiment 1. This embodiment provides a vacuum suction cup based on a snap-on type gasket structure constructed as shown in FIGS. 1-6, including a suction cup frame 1 and a handle 2 connected to each other, where a gasket 3 is provided at a bottom of the suction cup frame 1, the gasket 3 and the suction cup frame 1 are connected to each other by means of screws 4, a bracket 5 of a rigid material is provided in a middle portion of the gasket 3, the bracket 5 has an annular shape, the gasket 3 of a rubber material is molded over the bracket 5, and ends of the screws 4 pass through the bracket 5 and are threadedly connected to the suction cup frame 1.

An engaging groove 101 is provided on a periphery of the bottom of the suction cup frame 1, and the gasket 3 is in snap-fit connection with the engaging groove 101 at a periphery by virtue of an engaging portion 301, and the bracket 5 is located in a middle portion of the engaging portion 301 and is disposed in the engaging groove 101 together with the engaging portion 301.

An annular lip 302 is provided on a periphery of a bottom of the gasket 3, a lower end of the lip 302 forms a bevel for fitting with a surface of an object, an upper end of the lip 302 forms a deformation slot 303 having an elongated cross section, an upper end of the deformation slot 303 extends to an inside of the engaging groove 101, and a lower end of the deformation slot 303 is located outside the engaging groove 101.

An annular retaining edge 102 is formed on a periphery of the suction cup frame 1, a lower end of the retaining edge 102 is located vertically below a bottom surface of the engaging portion 301, and the lip 302 is located below the retaining edge 102 and is vertically spaced apart from the retaining edge 102.

A suction pump 6 and a power-on assembly is each provided in the handle 2. The power-on assembly includes a battery compartment 7 in snap-fit connection with the handle 2. An power connection plate 8 is provided at a lower end of the battery compartment 7. A power connection base 9 that is fixedly connected in the handle 2 is provided outside of the power connection plate 8. One end of the power connection base 9 fits with the power connection plate 8 via an elastic power-on portion 10. The elastic power-on portion 10 is a battery spring. The other end of the power connection base 9 is electrically connected to the suction pump 6. The battery compartment 7 is of a split structure and is formed by means of snap-fit. A battery and the power connection plate 8 are each snap-fit connected in the battery compartment 7. A lower end of the snap-fit connected battery is electrically connected to the power connection plate 8.

A cover plate 11 pivotally connected to handle 2 is provided at an outer end of the battery compartment 7. An end of the cover plate 11 extends inside the handle 2 and forms a hook 111, and a power-on button 12 is snap-fit connected outside the hook 111. An end of the power-on button 12 away from the hook 111 is in snap-fit connection with the handle 2. An inner side of the power-on button 12 is connected to the handle 2 via a first elastic member 13. A compression spring may be selected as the first elastic member 13. The power-on button 12 is used to release the cover plate 11 from the snap-fit limit after being pressed, and the elastic power-on portion 10 is used to exert an outward pressure on the battery compartment 7 after the cover plate 11 is released from the limit, such that the battery compartment 7 pushes the cover plate 11 open and pops out.

A suction pump 6 and a pressure relief assembly are each provided in the handle 2, and the bottom of the gasket 3 is recessed inwardly to create a suction chamber 14. The suction pump 6, the pressure relief assembly and the suction chamber 14 are in communication with one another. The pressure relief assembly includes an inlet and outlet pipe 15. A first vent 151, a second vent 152 and an exhaust port 153 are all provided on the inlet and outlet pipe 15. An exterior of the first vent 151 is connected to the suction pump 6 via a rubber hose, an exterior of the second vent 152 is in snap-fit connection with the suction cup frame 1 and communicates with the suction chamber 14, and a pressure relief button 16 is provided outside the exhaust port 153. The pressure relief button 16 is pivotally connected to the handle 2 in a middle portion. A plug 17 fitting with the exhaust port 153 is provided at one end of the pressure relief button 16, and the plug 17 is made of a flexible material and is in snap-fit with the pressure relief button 16. The pressure relief button 16 is provided with a pressing portion 161 for controlling the rotation of the pressure relief button 16 at the other end.

An opening 201 fitting with the pressing portion 161 is provided on a side wall of the handle 2. An outer end of the pressing portion 161 is in snap-fit with the opening 201 to form a seal, and an inner end of the pressing portion 161 is connected to the handle 2 via a second elastic member 18. A compression spring may be selected as the second elastic member 18. When the pressing portion 161 is depressed by an operator, the pressure relief button 16 rotates to cause the plug 17 to be opened to unblock the exhaust port 153, such that the gas in the suction chamber 14 is exhausted from the exhaust port 153 of the inlet and outlet pipe 15 to complete the pressure relief. When the operator releases the depressing, the second elastic member 18 rebounds to cause the pressure relief button 16 to rotate and return, and the plug 17 blocks the exhaust port 153 again such that the suction pump 6 can suction the gas in the suction chamber 14 through the inlet and outlet pipe 15 to achieve a gas suction function.

When the pressure relief button 16 is in a pressed state, a gap for gas circulation is formed between the pressing portion 161 and the opening 201, such that outside air enters the inlet and outlet pipe 15 from the gap. When the pressure relief button 16 is in a non-pressed state, the pressing portion 161 is snap-fitted to the opening 201 and closes the opening 201.

A gas pressure sensor 19 with a display function is externally connected to the inlet and outlet pipe 15 via a third exhaust port 154, and a display table of the gas pressure sensor 19 extends to an outer wall of the handle 2 and is used to display a value of the gas pressure in the suction chamber 14.

A third vent 304 in communication with the second vent 152 is provided in the middle portion of the gasket 3, and a dust-proof piece 20 is snap-fit connected in a middle portion of the third vent 304.

Operating principles of the present disclosure are provided as follows. In the use of the present disclosure, the operator first place the vacuum suction cup on a surface of the object, with a bottom of the lip 302 fitting with a suctioned surface of the object. The suction pump 6 is then turned on to suction out the air in the suction chamber 14 to achieve a suction effect. When the suction chamber 14 is in a negative-pressure vacuum state, the lip 302 is folded down under the atmospheric pressure and fits closely with the surface of the object to improve the sealing effect. At the same time, the plug 17 fits closely with the exhaust port 153 under the cooperation of the second elastic member 18 and the suction pump 6, such that the exhaust port 153 is maintained in a sealed state to ensure the suction effect of the suction pump 6 on the suction chamber 14.

When the vacuum suction cup completes a handling action, the operator presses the pressure relief button 16, and the operator depresses the pressing portion 161 to cause the pressure relief button 16 to rotate, such that the plug 17 is separated from the exhaust port 153 with the rotation. At the same time, the pressing portion 161 is separated from the opening 201 with the rotation, such that the outside air can sequentially pass through the opening 201, the exhaust port 153, the inlet and outlet pipe 15 and the third vent 304 into the suction chamber to achieve the pressure relief effect.

When it is necessary to remove the battery compartment 7 in the handle 2, the operator depresses the power-on button 12 to cause the power-on button 12 to be bent inwardly to release the cover plate 11 from the snap-fit limit. When the cover plate 11 is released from the limit, the resilience of the elastic power-on portion 10 will cause the battery compartment 7 to push the cover plate 11 open and pop out, thereby facilitating the removal of the battery compartment 7 by the operator. Similarly, when it is necessary to mount the battery compartment 7, the cover plate 11 may provide hard limit for the battery compartment 7 simply by the operator inserting the battery compartment 7 into the handle 2 and then flipping the cover plate 11 to a snap-fit position, that is, the stable fit of the power connection plate 8 with the elastic power-on portion 10 is ensured to ensure the stability of the electrical connection.

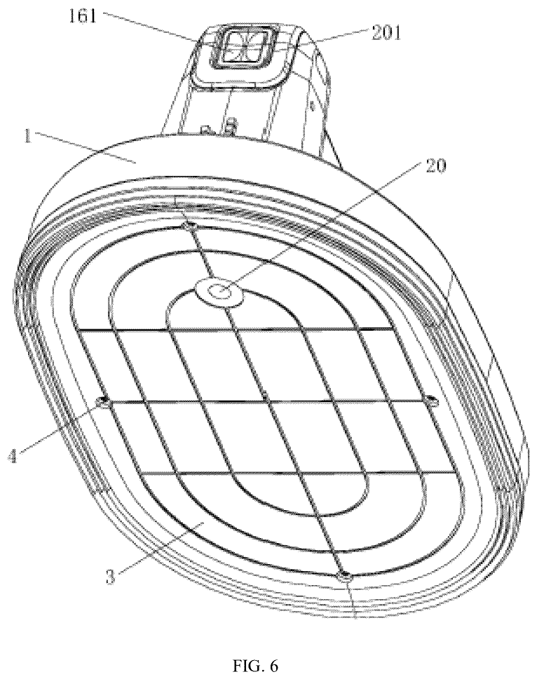

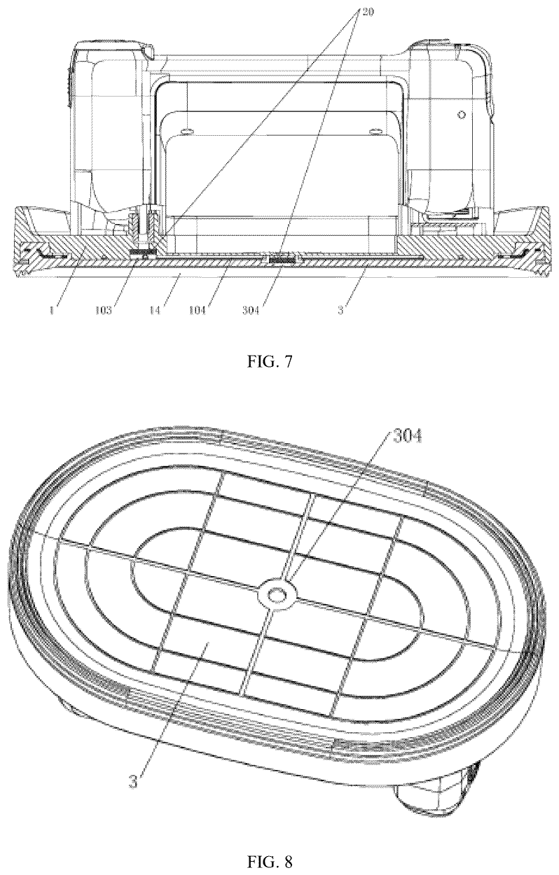

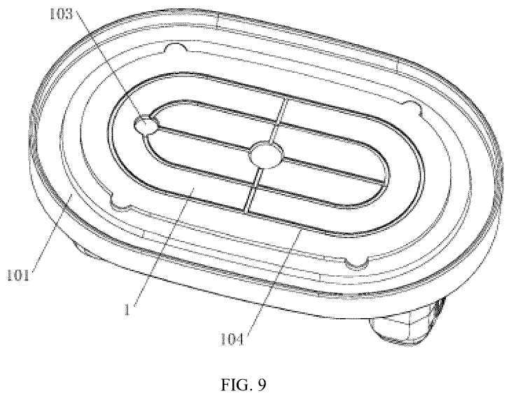

Embodiment 2. This embodiment provides a vacuum suction cup based on a snap-on type gasket structure constructed as shown in FIGS. 7-9, including a suction cup frame 1, a handle 2 and a gasket 3 connected to one another, where an engaging groove 101 is provided on a periphery of a bottom of the suction cup frame 1, the gasket 3 is in snap-fit connection with the engaging groove 101 at a periphery by virtue of an engaging portion 301, a bracket 5 located in the engaging groove 101 is provided in a middle portion of the gasket 3, the bracket 5 is made of a rigid material, and the gasket 3 of a rubber material is molded over the bracket 5.

An annular lip 302 is provided on a periphery of a bottom of the gasket 3, a lower end of the lip 302 forms a bevel for fitting with a surface of an object, an upper end of the lip 302 forms a deformation slot 303 having an elongated cross section, an upper end of the deformation slot 303 extends to an inside of the engaging groove 101, and a lower end of the deformation slot 303 is located outside the engaging groove 101.

An annular retaining edge 102 is formed on a periphery of the suction cup frame 1, a lower end of the retaining edge 102 is located vertically below a bottom surface of the engaging portion 301, and the lip 302 is located below the retaining edge 102 and is vertically spaced apart from the retaining edge 102.

A third vent 304 and a fourth vent 103 for ventilation are provided on the gasket 3 and the suction cup frame 1, respectively. The third vent 304 and the fourth vent 103 are misaligned with each other. A suction channel 104 is distributed on the bottom of the suction cup frame 1. Two sides of the suction channel 104 communicate with the third vent 304 and the fourth vent 103, respectively, and the suction channel 104 is configured to hold the gasket 3 in close fit with the suction cup frame 1 when the vacuum suction cup performs suction. A dust-proof piece 20 is snap-fit connected in a middle portion of each of the third vent 304 and the fourth vent 103.

A suction pump 6 and a power-on assembly is each provided in the handle 2. The power-on assembly includes a battery compartment 7 in snap-fit connection with the handle 2. An power connection plate 8 is provided at a lower end of the battery compartment 7. A power connection base 9 that is fixedly connected in the handle 2 is provided outside of the power connection plate 8. One end of the power connection base 9 fits with the power connection plate 8 via an elastic power-on portion 10. The elastic power-on portion 10 is a battery spring. The other end of the power connection base 9 is electrically connected to the suction pump 6. The battery compartment 7 is of a split structure and is formed by means of snap-fit. A battery and the power connection plate 8 are each snap-fit connected in the battery compartment 7. A lower end of the snap-fit connected battery is electrically connected to the power connection plate 8.

A cover plate 11 pivotally connected to handle 2 is provided at an outer end of the battery compartment 7. An end of the cover plate 11 extends inside the handle 2 and forms a hook 111, and a power-on button 12 is snap-fit connected outside the hook 111. An end of the power-on button 12 away from the hook 111 is in snap-fit connection with the handle 2. An inner side of the power-on button 12 is connected to the handle 2 via a first elastic member 13. A compression spring may be selected as the first elastic member 13. The power-on button 12 is used to release the cover plate 11 from the snap-fit limit after being pressed, and the elastic power-on portion 10 is used to exert an outward pressure on the battery compartment 7 after the cover plate 11 is released from the limit, such that the battery compartment 7 pushes the cover plate 11 open and pops out.

A suction pump 6 and a pressure relief assembly are each provided in the handle 2, and the bottom of the gasket 3 is recessed inwardly to create a suction chamber 14. The suction pump 6, the pressure relief assembly and the suction chamber 14 are in communication with one another. The pressure relief assembly includes an inlet and outlet pipe 15. A first vent 151, a second vent 152 and an exhaust port 153 are all provided on the inlet and outlet pipe 15. An exterior of the first vent 151 is connected to the suction pump 6 via a rubber hose, an exterior of the second vent 152 is in snap-fit connection with the suction cup frame 1 and communicates with the suction chamber 14, and a pressure relief button 16 is provided outside the exhaust port 153. The pressure relief button 16 is pivotally connected to the handle 2 in a middle portion. A plug 17 fitting with the exhaust port 153 is provided at one end of the pressure relief button 16, and the plug 17 is made of a flexible material and is in snap-fit with the pressure relief button 16. The pressure relief button 16 is provided with a pressing portion 161 for controlling the rotation of the pressure relief button 16 at the other end.

An opening 201 fitting with the pressing portion 161 is provided on a side wall of the handle 2. An outer end of the pressing portion 161 is in snap-fit with the opening 201 to form a seal, and an inner end of the pressing portion 161 is connected to the handle 2 via a second elastic member 18. A compression spring may be selected as the second elastic member 18. When the pressing portion 161 is depressed by an operator, the pressure relief button 16 rotates to cause the plug 17 to be opened to unblock the exhaust port 153, such that the gas in the suction chamber 14 is exhausted from the exhaust port 153 of the inlet and outlet pipe 15 to complete the pressure relief. When the operator releases the depressing, the second elastic member 18 rebounds to cause the pressure relief button 16 to rotate and return, and the plug 17 blocks the exhaust port 153 again such that the suction pump 6 can suction the gas in the suction chamber 14 through the inlet and outlet pipe 15 to achieve a gas suction function.

When the pressure relief button 16 is in a pressed state, a gap for gas circulation is formed between the pressing portion 161 and the opening 201, such that outside air enters the inlet and outlet pipe 15 from the gap. When the pressure relief button 16 is in a non-pressed state, the pressing portion 161 is snap-fitted to the opening 201 and closes the opening 201.

A gas pressure sensor 19 with a display function is externally connected to the inlet and outlet pipe 15 via a third exhaust port 154, and a display table of the gas pressure sensor 19 extends to an outer wall of the handle 2 and is used to display a value of the gas pressure in the suction chamber 14.

Compared to Embodiment 1, in this embodiment, the screws 4 between the gasket 3 and the suction cup frame 1 are dispensed with, and the third vent 304, the fourth vent 103 and the suction channels 104 cooperate to enable the vacuum suction cup to suction the gas in the suction chamber 14 out through the third vent 304, the suction channel 104 and the fourth vent 103 in sequence. The suction channel 104 after the suction together with the suction chamber 14 is in a negative-pressure state, and then the suction cup frame 1 and the gasket 3 are attracted to each other on two sides of the suction channel 104, thereby improving the stability of the gasket 3 in this state, and preventing the gasket 3 from shifting or falling off during handling.

On the other hand, the structural cooperation of the third vent 304, the fourth vent 103 and the dust-proof pieces 20 also enable a dual dust-proof structure to be formed for the vacuum suction cup, further reducing the possibility of clogging due to the entry of impurities into the suction cup frame 1 or handle 2.

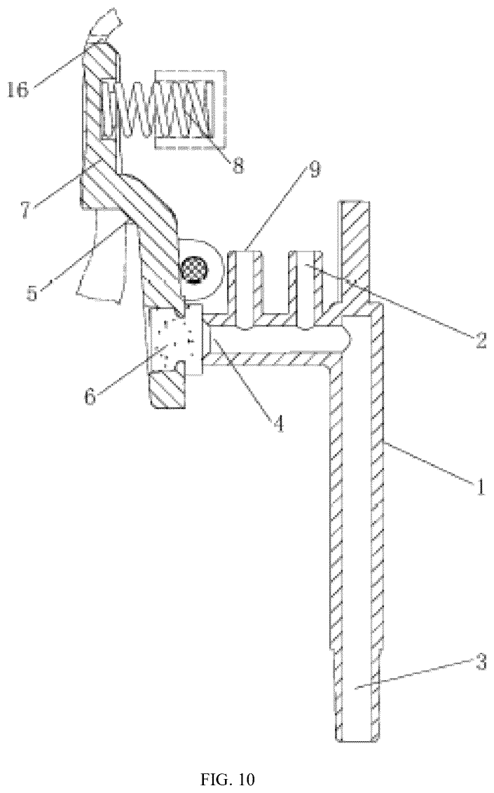

Embodiment 3. This embodiment provides a quick pressure relief mechanism for a vacuum suction cup, which corresponds to the pressure relief assembly of the previous embodiments. The quick pressure relief mechanism is constructed as shown in FIG. 10 and includes an inlet and outlet pipe 1 fixed in the vacuum suction cup. A first vent 2, a second vent 3 and an exhaust port 4 are all provided on the inlet and outlet pipe 1. The first vent 2 is configured to be connected to a suction pump, the second vent 3 is configured to be connected to a suction chamber, and a pressure relief button 5 is provided outside the exhaust port 4. The pressure relief button 5 is pivotally connected to the vacuum suction cup in a middle portion. A plug 6 fitting with the exhaust port 4 is provided at one end of the pressure relief button 5, and the plug 6 is made of a flexible material and is in snap-fit with the pressure relief button 5. The pressure relief button 5 is provided with a pressing portion 7 for controlling the rotation of the pressure relief button 5 at the other end.

An inner side of the pressing portion 7 is connected to the vacuum suction cup via an elastic member 8. When the pressing portion 7 is depressed by an operator, the pressure relief button 5 rotates to cause the plug 6 to be opened to unblock the exhaust port 4, such that the gas in the suction chamber is exhausted from the exhaust port 4 of the inlet and outlet pipe 1 to complete the pressure relief. When the operator releases the depressing, the elastic member 8 rebounds to cause the pressure relief button 5 to rotate and return, and the plug 6 blocks the exhaust port 4 again such that the suction pump can suction the gas in the suction chamber through the inlet and outlet pipe 1 to achieve a gas suction function.

The elastic member 8 is a compression spring with one end in snap-fit connection with the vacuum suction cup and the other end fitting with an inner end face of the pressing portion 7.

An opening 16 for snap-fit connection with the pressing portion 7 is provided on a side wall of the vacuum suction cup, and when the pressure relief button 5 is in a non-pressure relief state, the pressing portion 7 is snap-fitted to the opening 16 and closes the opening 16. When the pressure relief button 5 is in a pressure relief state, a gap is formed between the pressing portion 7 and the opening 16, and the outside air enters the inlet and outlet pipe 1 through the exhaust port 4.

A detection port 9 for connection to a gas pressure sensor is provided on the inlet and outlet pipe 1.

When the vacuum suction cup is in a negative-pressure vacuum state, the plug 6 fits closely with the exhaust port 4 under the cooperation of the elastic member 8 and the suction pump, such that the exhaust port 4 is maintained in a sealed state to ensure the suction effect of the suction pump on the suction chamber. When it is necessary to relieve the pressure of the suction chamber, the operator presses the pressing portion 7 to cause the pressure relief button 5 to rotate, such that the plug 6 is separated from the exhaust port 4 with the rotation. At the same time, the pressing portion 7 is separated from the opening 16 with the rotation, such that the outside air can sequentially pass through the opening 16, the exhaust port 4, the inlet and outlet pipe 1 and the second vent 3 into the suction chamber to achieve the pressure relief effect.

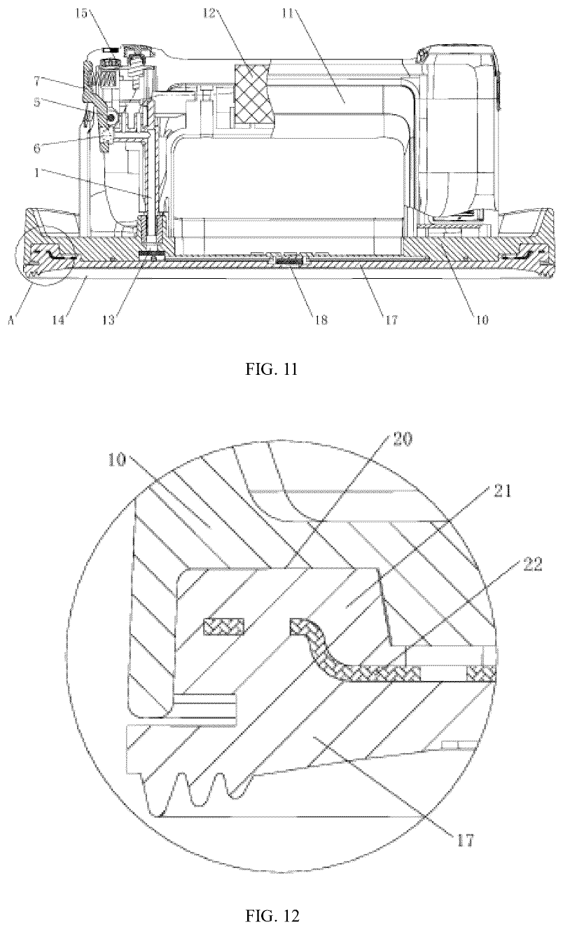

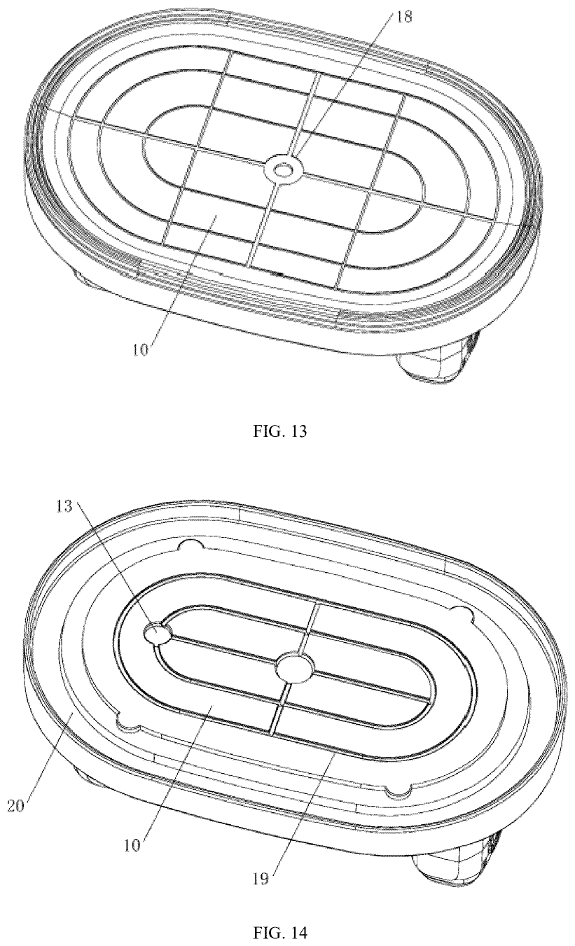

Embodiment 4. This embodiment provides a vacuum suction cup constructed as shown in FIGS. 11-14, including the quick pressure relief mechanism for a vacuum suction cup in Embodiment 1. The vacuum suction cup includes a suction cup frame 10 and a handle 11 connected to each other, where a suction pump 12 is connected in the handle 11, and a first gas passage hole 13 for ventilation is provided on the suction cup frame 10. A suction chamber 14 is formed outside the first gas passage hole 13, and two ends of the inlet and outlet pipe 1 are connected to the suction pump 12 and the suction chamber 14 via the first vent 2 and the second vent 3, respectively. The pressure relief button 5 is pivotally connected in the handle 11, and the elastic member 8 is snap-fit connected in the handle 11.

A gas pressure sensor 15 with a display function is externally connected to the detection port 9 via a rubber hose, and a display table of the gas pressure sensor 15 extends to an outer wall of the handle 11 and is used to display a value of the gas pressure in the suction chamber 14.

An opening 16 fitting with the pressing portion 7 is provided on a side wall of the handle 11, and when the pressure relief button 5 is in a pressed state, a gap for gas circulation is formed between the pressing portion 7 and the opening 16. When the pressure relief button 5 is in a non-pressed state, the pressing portion 7 is snap-fit connected in the opening 16 and closes the opening 16.

A gasket 17 is detachably connected to a lower end of the suction cup frame 10, a middle portion of the gasket 17 is recessed inwardly to create the suction chamber 14, and a second gas passage hole 18 in communication with the first gas passage hole 13 is provided on the gasket 17.

An engaging groove 20 is provided on a periphery of a bottom of the suction cup frame 10, the gasket 17 is in snap-fit connection with the engaging groove 20 at a periphery by virtue of an engaging portion 21, a bracket 22 of a rigid material is provided in a middle portion of the engaging portion 21, the bracket 22 has an annular outline, and the gasket 17 of a rubber material is molded over the bracket 22.

The first gas passage hole 13 and the second gas passage hole 18 are misaligned with each other in a horizontal direction, and the first gas passage hole 13 and the second gas passage hole 18 communicate with each other via a suction channel 19 at the bottom of the suction cup frame 10. The suction channel 19 is configured to be in a negative-pressure state and hold the gasket 17 in close fit with the suction cup frame 10 when the vacuum suction cup is operated.

A dust-proof piece is snap-fit connected in each of the first gas passage hole 13 and the second gas passage hole 18. The dust-proof pieces allow for dual filtration of the gas paths of the vacuum suction cup, thus preventing the possibility of clogging due to the entry of external impurities into the gasket 17 or the suction cup frame 10.

In this embodiment, the quick gas exhaust mechanism of Embodiment 1 is mounted in the handle 11 of the vacuum suction cup, such that the user can achieve stable pressure relief of the suction chamber 14 by pressing the pressing portion 7. On this basis, the gasket is in snap-fit connection with the engaging groove 20 by virtue of the engaging portion 21 with the bracket 22, such that the connection stability between the engaging portion 21 and the engaging groove 20 can be improved, preventing the engaging portion 21 from peeling off the engaging groove 20 due to deformation caused by a local stress. Further, the cooperation of the first gas passage hole 13, the second gas passage hole 18 and the suction channel 19 allows the suction channel 19 to be kept in a negative-pressure state after the vacuum suction cup performs suction, thereby suctioning the underlying gasket 17, i.e., preventing the possibility of shifting and falling-off of the entire gasket 17 from the suction cup frame 10 under a stress.

What is claimed is:

1. A vacuum suction cup based on a snap-on type gasket structure, comprising a suction cup frame (1), a handle (2) and a gasket (3) connected to one another, wherein an engaging groove (101) is provided on a periphery of a bottom of the suction cup frame (1), the gasket (3) is in snap-fit connection with the engaging groove (101) at a periphery by virtue of an engaging portion (301), and a bracket (5) located in the engaging groove (101) is provided in a middle portion of the gasket (3).

2. The vacuum suction cup based on a snap-on type gasket structure according to claim 1, wherein an annular lip (302) is provided on a periphery of a bottom of the gasket (3), an upper end of the lip (302) forms a deformation slot (303) having an elongated cross section, an upper end of the deformation slot (303) extends to an inside of the engaging groove (101), and a lower end of the deformation slot (303) is located outside the engaging groove (101).

3. The vacuum suction cup based on a snap-on type gasket structure according to claim 2, wherein an annular retaining edge (102) is formed on a periphery of the suction cup frame (1), a lower end of the retaining edge (102) is located vertically below a bottom surface of the engaging portion (301), and the lip (302) is located below the retaining edge (102) and is vertically spaced apart from the retaining edge (102).

4. The vacuum suction cup based on a snap-on type gasket structure according to claim 1, wherein the suction cup frame (1) and the gasket (3) are connected to each other by means of screws (4), ends of the screws (4) passing through the bracket (5) and being threadedly connected to the suction cup frame (1).

5. The vacuum suction cup based on a snap-on type gasket structure according to claim 1, wherein a third vent (304) and a fourth vent (103) for ventilation are provided on the gasket (3) and the suction cup frame (1), respectively, the third vent (304) and the fourth vent (103) being misaligned with each other, and a suction channel (104) is distributed on the bottom of the suction cup frame (1), two sides of the suction channel (104) communicating with the third vent (304) and the fourth vent (103), respectively, and the suction channel (104) being configured to hold the gasket (3) in close fit with the suction cup frame (1) when the vacuum suction cup performs suction; and a dust-proof piece (20) is snap-fit connected in a middle portion of each of the third vent (304) and the fourth vent (103).

6. The vacuum suction cup based on a snap-on type gasket structure according to claim 1, wherein a suction pump (6) and a power-on assembly are each provided in the handle (2), the power-on assembly comprising a battery compartment (7) in snap-fit connection with the handle (2), a power connection plate (8) being provided at a lower end of the battery compartment (7), a power connection base (9) that is fixedly connected in the handle (2) being provided outside of the power connection plate (8), one end of the power connection base (9) fitting with the power connection plate (8) via an elastic power-on portion (10), and the other end of the power connection base (9) being electrically connected to the suction pump (6).

7. The vacuum suction cup based on a snap-on type gasket structure according to claim 6, wherein a cover plate (11) pivotally connected to the handle (2) is provided at an outer end of the battery compartment (7), wherein an end of the cover plate (11) extends inside the handle (2) and forms a hook (111), a power-on button (12) is snap-fit connected outside the hook (111), an end of the power-on button (12) away from the hook (111) is in snap-fit connection with the handle (2), and an inner side of the power-on button (12) is connected to the handle (2) via a first elastic member (13).

8. The vacuum suction cup based on a snap-on type gasket structure according to claim 1, wherein a suction pump (6) and a pressure relief assembly are each provided in the handle (2), a bottom of the gasket (3) is recessed inwardly to create a suction chamber (14), and the suction pump (6), the pressure relief assembly and the suction chamber (14) are in communication with one another; and the pressure relief assembly comprises an inlet and outlet pipe (15), a first vent (151), a second vent (152) and an exhaust port (153) being all provided on the inlet and outlet pipe (15), an exterior of the first vent (151) being connected to the suction pump (6), an exterior of the second vent (152) being connected to the suction chamber (14), a pressure relief button (16) being provided outside the exhaust port (153), the pressure relief button (16) being pivotally connected to the handle (2) in a middle portion, a plug (17) fitting with the exhaust port (153) being provided at one end of the pressure relief button (16), and the pressure relief button (16) being provided with a pressing portion (161) for controlling the rotation of the pressure relief button (16) at the other end.

9. The vacuum suction cup based on a snap-on type gasket structure according to claim 8, wherein an opening (201) fitting with the pressing portion (161) is provided on a side wall of the handle (2), an outer end of the pressing portion (161) is in snap-fit with the opening (201), and an inner end of the pressing portion (161) is connected to the handle (2) via a second elastic member (18); and when the pressure relief button (16) is in a pressed state, a gap for gas circulation is formed between the pressing portion (161) and the opening (201).

10. The vacuum suction cup based on a snap-on type gasket structure according to claim 8, wherein a gas pressure sensor (19) is externally connected to the inlet and outlet pipe (15).

11. The vacuum suction cup based on a snap-on type gasket structure according to claim 1, wherein the vacuum suction cup comprises a pressure relief assembly, wherein the pressure relief assembly comprises an inlet and outlet pipe (1) located in the vacuum suction cup, a first vent (2), a second vent (3) and an exhaust port (4) being all provided on the inlet and outlet pipe (1), the first vent (2) being configured to be connected to a suction pump, the second vent (3) being configured to be connected to a suction chamber, a pressure relief button (5) being provided outside the exhaust port (4), the pressure relief button (5) being pivotally connected to the vacuum suction cup in a middle portion, a plug (6) fitting with the exhaust port (4) being provided at one end of the pressure relief button (5), and the pressure relief button (5) being provided with a pressing portion (7) for controlling the rotation of the pressure relief button (5) at the other end.

12. The vacuum suction cup based on a snap-on type gasket structure according to claim 11, wherein an inner side of the pressing portion (7) is connected to the vacuum suction cup via an elastic member (8).

13. The vacuum suction cup based on a snap-on type gasket structure according to claim 12, wherein the elastic member (8) is a compression spring with one end in snap-fit connection with the vacuum suction cup and the other end fitting with an inner end face of the pressing portion (7).

14. The vacuum suction cup based on a snap-on type gasket structure according to claim 11, wherein a detection port (9) for connection to a gas pressure sensor is provided on the inlet and outlet pipe (1).

15. The vacuum suction cup based on a snap-on type gasket structure according to claim 11, wherein the suction pump (12) is connected in the handle (11), a first gas passage hole (13) for ventilation is provided on the suction cup frame (10), the suction chamber (14) is formed outside the first gas passage hole (13), two ends of the inlet and outlet pipe (1) are connected to the suction pump (12) and the suction chamber (14) via the first vent (2) and the second vent (3), respectively, and the pressure relief button (5) is pivotally connected in the handle (11).

16. The vacuum suction cup based on a snap-on type gasket structure according to claim 15, wherein an opening (16) fitting with the pressing portion (7) is provided on a side wall of the handle (11), and when the pressure relief button (5) is in a pressed state, a gap for gas circulation is formed between the pressing portion (7) and the opening (16).

17. The vacuum suction cup based on a snap-on type gasket structure according to claim 15, wherein the gasket (17) is detachably connected to a lower end of the suction cup frame (10), a middle portion of the gasket (17) is recessed inwardly to create the suction chamber (14), and a second gas passage hole (18) in communication with the first gas passage hole (13) is provided on the gasket (17).

18. The vacuum suction cup based on a snap-on type gasket structure according to claim 17, wherein a bracket (22) is provided in a middle portion of the engaging portion (21).

19. The vacuum suction cup based on a snap-on type gasket structure according to claim 17, wherein the first gas passage hole (13) and the second gas passage hole (18) communicate with each other via a suction channel (19) at the bottom of the suction cup frame (10), the suction channel (19) being configured to be in a negative-pressure state and hold the gasket (17) in close fit with the suction cup frame (10) when the vacuum suction cup is operated.
